(19) United States
(12) Patent Application Publication
(10) Pub. No.: US 2013/0264440 A1
(43) Pub. Date: Oct. 10, 2013

(54) FREE-STANDING STORAGE TABLE FOR HOLDING CUPS ABOVE A SANDY SUBSURFACE

(71) Applicants: Annette Auracher, Munich (DE); André Gruenewald, Munich (DE)

(72) Inventors: Annette Auracher, Munich (DE); André Gruenewald, Munich (DE)

(21) Appl. No.: 13/814,071

(22) PCT Filed: Jul. 15, 2011
(86) PCT No.: PCT/IB11/53173

§ 371 Date: Jun. 13, 2013

(30) Foreign Application Priority Data
Aug. 3, 2010 (DE) 102010036823.7
Dec. 10, 2010 (EP) PCT/EP2010/069366
May 5, 2011 (DE) 102011050146.0

(51) Int. Cl. A45F 3/44; F16M 13/00

(52) U.S. Cl. CPC A45F 3/44; F16M 13/00
USPC 248/149; 211/133.6; 248/156; 29/426.1

(57) ABSTRACT

The invention creates a storage option that can be set up individually and sits securely on a sandy subsurface, whereby the placement of beverage vessels is achieved in a service-friendly manner. The tray used for this purpose is held in a stable manner, yet can be removed. For this purpose, a storage element that can be set up as a cup holder above the subsurface is proposed as a two-part system. A straight mandrel is provided, comprising an upper and a lower section, wherein the lower section is adapted for being turned or inserted into the subsurface. At a certain height above the end of the lower section, the straight mandrel has a horizontally extending structure which is adapted and suitable as a holding support for the tray-like storage element. The storage element has an opening, which is guided over the upper section of the mandrel in order to rest on the horizontal structure and be held there.

The invention relates to an individually positionable deposit facility and its components. The deposit facility can be positioned on a sandy subsurface, e.g. on beaches, in gravelly soil, e.g. by a lake or river, or in snowy climes, e.g. outdoors at a ski or mountain lodge. The deposit table stands freely and by itself offering itself for depositing cups (as well as drinking glasses).

### PREVIOUS OPTIONS

### Prior Art

Personal objects and drinking vessels (in most cases only plastic cups with and without drinking straw are allowed due to the risks of breakage and injury associated therewith) and ashtrays are placed next to the loungers. Due to the condensed water formed on the outside of the cups, sand adheres to the drinking vessels and the standing position is highly insecure.

Small tables made of plastic material matched to the dimensions of the lounger. The objects (plastic cups, ashtrays and the like) deposited and placed thereon have an insecure standing position due to floor unevenness (table not standing straight) and the possibility of bumping into the table. Moreover, they are subject to wind and are blown off the table when empty due to their low empty weight.

A tray-shaped deposit means mounted directly to the sunshade. Also in this case, there is the risk of drinking vessels falling off due to wind. Furthermore, this position is highly uncomfortable since one always has to rise from the lounger when intending to drink.

In addition, all three known options have the same basic problems: In most cases the drinking vessels are left behind by the beach goer just as carelessly as the cigarette ends stuck into the sand. The cups are driven across the beach and cigarette ash is blown out of the ashtrays by the wind.

This involves a significant cleaning effort for the beach keeper which is ensured by both service staff and machines (tractor-like cleaning vehicles).

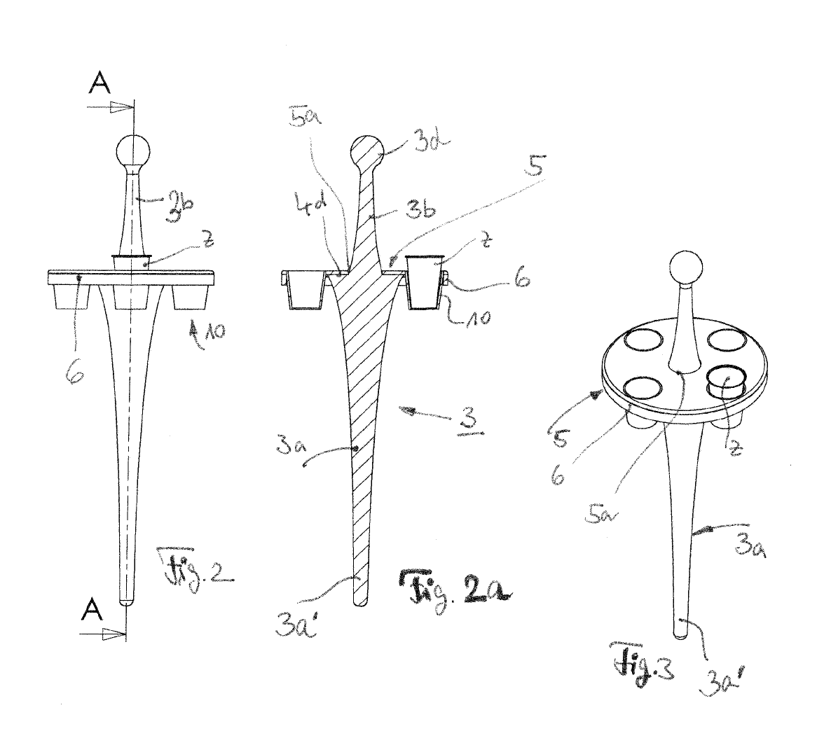

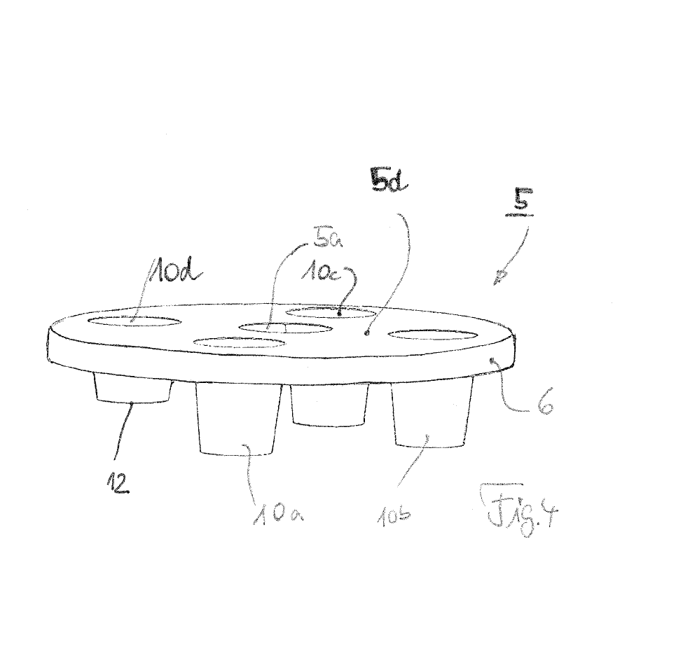

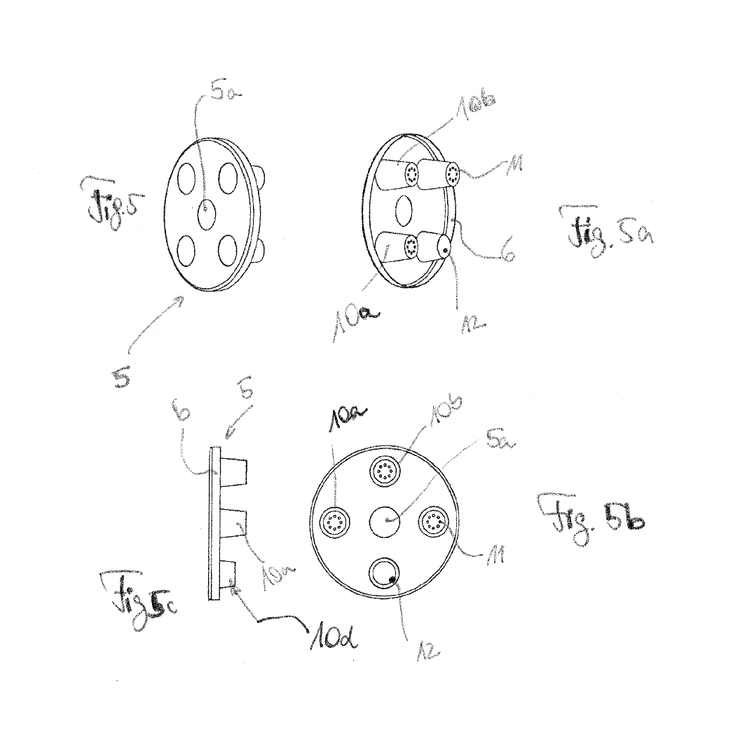

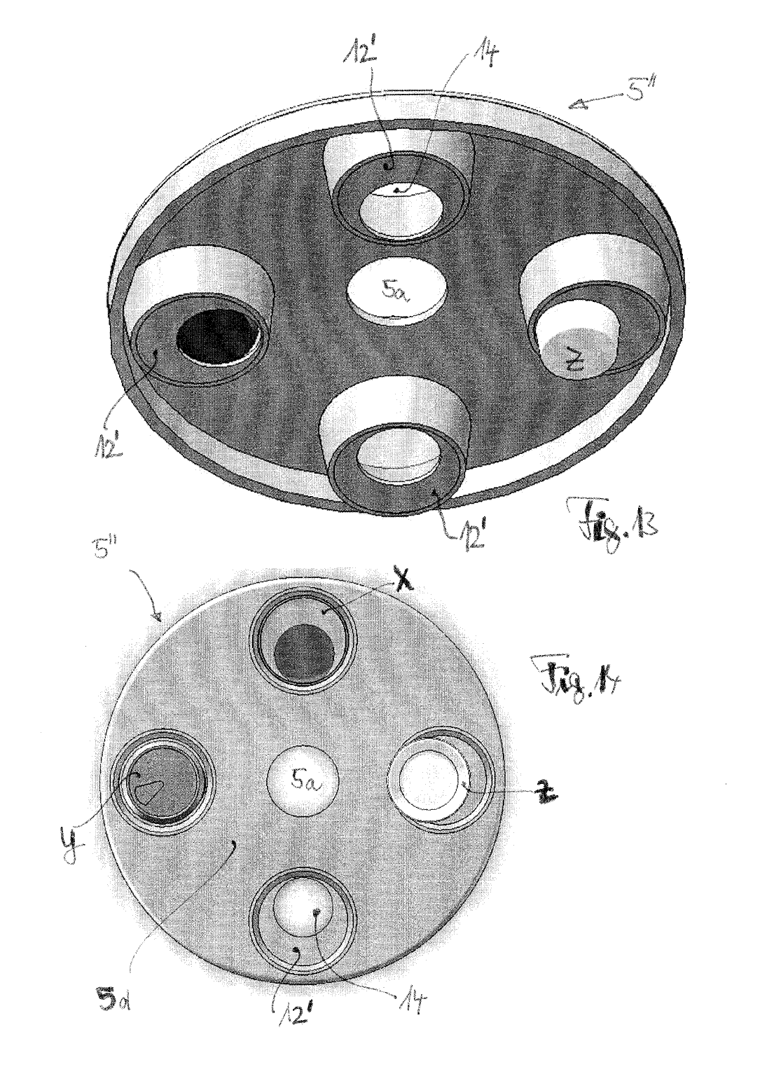

Excerpts from prior art include U.S. Pat. No. 716,560 dated 23 Sep. 1902 which discloses a camp stove comprising a flat plate with openings, cf. FIG. 4 therein. Said plate rests on a supporting frame having a cross-shaped structure when viewed in a vertical direction and comprising a transversely inserted bearing pin (FIGS. 3, 12, therein), on which the plate structure provided with a central hole may rest on. Due to the insecure support, a further transverse hole is provided above the plate in the vertical mandrel, through which a further bar can be inserted in a direction offset by 90°. The plate is then held between the two bar-shaped cross pieces and may serve as a tray-shaped deposit means for cooking utensils. The tray-shaped deposit means is held relatively stably and remains rotatable according to the statement made therein on page 1, lines 47 to 58.

Other solutions for tray-shaped deposit means are known from U.S. Pat. No. D 366,372 and U.S. Pat. No. 4,920,897. In the former, a plurality of tubes are provided in a tray-shaped deposit means which are arranged in a circumferentially distributed manner and a central opening of the tray rests on a substantially straight mandrel, from which it may also be removed. The said US '897 shows a receiving block (16 therein) for receiving and supporting the tray, which block comprises a horizontal surface area extending to a certain extent on which the tray may rest, however, on which it is not supported stably enough which is why a square block protruding upwards for preventing a rotational movement of the tray is provided, against which the tray is centrically fixed and fastened in a torsionally stiff manner.

It is the object of the invention to provide an individually positionable deposit facility having a safe standing position on one of the mentioned subsurfaces on which the placement or accommodation of objects, drinking vessels and the like or a safe disposal option for e.g. tobacco products is ensured in a manner easy to service. The tray used for this purpose is to be held stably and be removable nevertheless.

The system according to the invention makes use of two pieces which can be assembled (claim 1). One aspect of the invention is a method of operation (claim 29). The components of the individually positionable deposit means (claims 1, 35) include the removable tray-shaped deposit means (claim 30) and the substantially straight mandrel (claim 22).

It is referred to the independent claims. They are incorporated herein.

The object is achieved by a single-leg deposit means (claim 1). Said means serves as a cup holder, wherein the cup is supported above the subsurface. The single-leg deposit means is provided with a substantially straight mandrel having an upper and a lower portion. The lower portion can be turned into the subsurface or is inserted into the subsurface. The straight mandrel comprises a horizontal support structure at a specific height where the lower portion ends, which structure is, for example, shaped as a ring. It is adapted to stably support the tray-shaped deposit means. The supporting involves the resting of the tray on the horizontal support structure.

In order to be able to connect the tray-like deposit means with the mandrel, an opening is provided in this deposit means, which is guided over the upper portion of the mandrel. The guiding moves the deposit means towards the horizontal support structure on which the tray rests.

When the mandrel is turned into a sandy or snowy or gravelly subsurface, a spiral can be provided (claim 12). In order to achieve or facilitate or at all enable the turning in, a grab handle (operating handle) having the shape of a sphere may be provided, by means of which the user inserts or turns the mandrel into the subsurface.

The supporting function which is provided by the horizontally extending structure, briefly also referred to as “horizontal structure”, is adjusted to the tray. In the case of a combination of tray and mandrel, a relation may be formed, wherein the horizontal extension has to include the horizontal structure so that the tray stably rests on the structure for use without the need for any additional fastening variants or facilities. Neither screws for fixing the tray, nor additional elements engaging from above are required, nor does the tray need to be tightened via a thread. It is merely guided over the upper portion of the mandrel and then rests stably (functionally stably) on the horizontal support structure.

Stability arises from the fact that the number of cups or drinking vessels placed on the tray must not result in a tilting of the tray. The tray must remain seated horizontally on the horizontal structure when the mandrel is vertically inserted into the subsurface.

In order to ensure that the tray will not rest on the horizontal structure due to its high empty weight alone and to enable it to be built slimly and light-weight, the invention uses various definitions of the design and aptitude of the horizontal structure with respect to the tray (claims 3, 8, 20). When starting from a round tray and when the support structure is round as well at least on the outside, the outer dimensions of the support structure is at least 40% of the diameter of a round tray (claim 3). Calculated therefrom in terms of surface area, the surface area of the horizontal support structure is at least 16%, preferably 20% of the surface area of the tray (claim 20). Stability proves itself when beverages or cups are placed on the tray in a non-symmetrical manner. When the drinking vessels are placed symmetrically thereon, there is no asymmetry in load, however, maximum asymmetry, for example two or three drinking vessels placed in a 90° sector of the tray and each drinking vessel filled with “Cuba Libre” might affect stability of the tray out of the horizontal position. Here, the invention takes effect by means of the definition of the horizontal support structure and prevents the tray from tilting under such a maximum unbalanced load.

This kind of stability “oriented towards intended use” (=functional stability) is, of course, limited to the intended use and is not stable in general terms.

When it comes to absolute values, the planar horizontal structure effectively is at least 20 cm², preferably greater than 40 cm² in size (claim 8). This dimensioning is adapted to the fact that a mandrel (claim 22) may not have, for example, a relative indication with respect to a size of the tray, as it is claimed independently of the tray. The shape of horizontal structure is not necessarily round in terms of the horizontally extending structure, but may have other shapes, such as square, star-shaped or polygon-like. In such configurations, the definition of a diameter ratio fails, at best the indicated absolute surface area or a relative indication with respect to the surface area of the tray (claim 20) may be of help. The surface area of the tray-shaped deposit means is used to define the effective surface area of the horizontal structure. This surface area is greater than 10%, preferably greater than 16% or even 20% of the surface area of the tray-shaped deposit means. In the case of an effective surface area, this is defined such that the surface effect is not achieved all-over the said at least 10%. The surface may be, for example, a circle (a round disk) having a plurality of through holes in its surface extension. Then, the actual physical surface is smaller, however, the effective surface area is the disk with the outer circumference of the circle and the inner surface defined thereby. When the circular disk comprises an inner hole or an inner protrusion which may be brought about, for example, by the upwards extending upper portion of the mandrel, the internal surface dimension defined by the outer circumference of the horizontal support structure is applicable all the same which dimension is located at a constant height regardless of the fact that no surface area is formed below the protrusion of the upper portion of the mandrel on which the tray is adapted to rest. It rather rests on the supporting horizontal structure outside this upwards extending portion beginning at the circumference.

In line with this mode of thought, a plurality of flat bars arranged in the shape of a star may also define this effective surface extension. The inner dimension defined by the ends of the bars forms the effective surface area, even though the actual surface area is, from a physical point of view, smaller than the effective surface area formed by the flat bars protruding in the shape of a star.

This, at least in sections, planar configuration (claim 7) expresses that just as the term ‘effective surface area’ (claim 8).

By means of such a configuration, the tray can be made both light-weight and thin, it does not require an edge protruding downwards from the edge in order to be fixed to another structure. The tray remains rotatable on the planar structure all the same and is held stably thereon in terms of the above defined intended use.

In a preferred embodiment, a stop against excessive lateral slipping may be added to the holding function. This stop against excessive lateral slipping can take various variants (claim 17).

The transverse displacement (lateral slipping) can be limited to a maximum dimension of less than 1 cm, preferably less than 5 mm. This can be achieved by existing tubes or tubular inserts (claim 13) distributed in the tray in such a manner that they abut the horizontally extending structure in case of a lateral displacement of the tray exceeding the said maximum dimension. Thus, a further transverse displacement is blocked. In other words, the transverse displacement is not greater than 1 cm, however, does not have to be present when the tubes are adjusted more precisely to the outer dimensions of the horizontally extending structure. Then, a centering effect is created by the tubular inserts which completely block a lateral displacement.

When attaching the tray to the mandrel (guiding the central opening over the upper portion of the substantially straight mandrel), the tubes can also have a centering effect. The centering effect is improved when the tubes are, at least in sections, conical in shape, for example, at their lower end portion. The tubes can also be conical along their entire height or they can be cylindrical which is advantageously associated with a certain tolerance¹ permitted to move the tubes past the horizontal support structure during placement of the tray. ¹There was a typo “Spiegel” (mirror) in the German wording, correctly understood as “Spiel” (tolerance).

In addition or alternatively to the mentioned tubes, the upper portion of the substantially straight mandrel can be used for centering. The diameter of the central hole of the tray is adjusted to the transverse extension of the lower end of the upper portion. In the case of a circular adjustment, the tray continues to remain rotatable. The centering effect is enabled by the vertical opening of the tray and lateral slipping is likewise blocked.

These two variants of centering and blocking a greater lateral slipping can be used individually or in combination. Complete centering is virtually the maximum prevention of any lateral displacement. When the centering is regarded in a more general sense, a small transverse displacement can be permitted which also constitutes a “substantial” centering.

Tilt protection for the tray-shaped deposit means is thus combined with a stop against excessive lateral slipping. This creates the impression of operational stability in the user, while nevertheless maintaining ease of removal of the tray from the mandrel.

The upper portion of the mandrel can be particularly short (claims 10, 9). It is thus diminished to some kind of stub-like protrusion which is just sufficient to extend through the central opening of the tray and have a centering effect (claim 11). The tray is stably held on the horizontal support structure being present as well—for the mentioned intended use—and is at least substantially, preferably precisely centered in the transverse direction. The mere protrusion (claim 10) is virtually a rudimentary upper portion which may also be more prominent (claim 23, 24 or 25).

Finally, according to a further aspect of the invention, it is also possible that a central hole is not provided at all in the tray so that there is no protrusion above the horizontally extending structure. Such a combination (claim 35) is comprised of a substantially straight mandrel having a lower portion only, and the above defined horizontally extending structure which is adapted and suited for the height-keeping support of the tray-shaped deposit means not comprising a central hole but a number of circumferentially distributed tubes which in a combined effect with the horizontal support structure provide a centering effect during attachment as well as a stop against excessive lateral slipping in the attached state. The defined functional relationships for the configuration of the tubes (conical or cylindrical in shape, at least in portions) and their adjustment to the shape, in particular, also to the outer dimensions of the horizontal structure on which they abut for centering or blocking in a lateral direction, can be applied here. The maximum transverse displacement is less than 1 cm, preferably less than 0.5 cm, to convey a stable, functional impression to the user. A lateral displacement of less than 1 cm is not a transverse displacement at all. Releasing or/and attaching the tray from the mandrel or to the mandrel is a method of operation (claim 29).

A plurality of trays may be provided (claim 16). Also in this case, the individual deposit means for the cup or glass is configured such that it holds the vessel(s) above the subsurface so that the vessel(s) does/do not need to be placed on the subsurface. Vessels and subsurface have a distance dimension which is substantially dependent on the distance of the horizontal support structure from the lower end of the mandrel to and the depth of insertion or turning in.

If performing the procedure of connecting the tray-like deposit means with the mandrel in the other direction is regarded as a releasing action (the alternative according to claim 29), the inverse direction of movement for the tray-like deposit means is obtained. The stable support is released, which can be achieved by an axial upward movement of the tray-like deposit means, and the tray is removed from the mandrel and can be stored separately.

The mandrel is substantially straight (claim 22). Its front end is adapted for inserting or turning in and the horizontally extending support structure which is adapted as a support for the tray-like deposit means (and is thus also suitable for this purpose) is located above the lower portion. The tray-like deposit means comprises the opening which is guided over the upper portion of the mandrel for attachment. For releasing the tray, the opening is removed from the mandrel in the opposite direction. When attached, the horizontal structure supports the tray-like deposit means. It rests on it. It may be held thereon such that it cannot be pushed further downwards in the axial direction of the mandrel.

The horizontally extending support structure may be shaped as a ring (claims 2, 26). The ring shape has a ring plane which has a “sufficient” supporting effect on the tray-like deposit means. If the tray-like deposit means is slid over the upper portion in a downward direction, the tray-shaped deposit means (in short: tray) comes to rest on the horizontally extending support structure and rests there in such a stable manner that it rests stably thereon without the need for further screwing or adhesive fasteners (claim 25).

A minimum extension of the exemplary ring shape provides the tray-shaped deposit means with stability (claims 3, 36, 37, 38). If the outside of the ring shape is at least 40% of the diameter of the tray-shaped deposit means, the tray will rest stably thereon. In addition, it is supported by the upper portion which extends upwards on the inside and preferably tapers in an upward direction (claims 4, 27). This corresponds to an expansion (broadening) in a downward direction. Seen the other way round, the lower portion of the mandrel may expand (broaden) in an upward direction, in fact more pronounced and to a greater extent than the upper portion expands in the downward direction. Thus, a step is created where the tray is attached, said step having said ring shape and being horizontally planar at the top.

The two ends, i.e. the lower end of the upper portion and the upper end of the lower portion, are not identical in dimension (in diameter in the example), whereby the ring-shaped step is formed (claim 23).

The tray rests on the, in particular, ring-shaped step of the mandrel which is composed is of the upper portion and the lower portion.

In addition, the upper portion may be decorated by comprising a handle knob at the upper end (claims 5, 24). However, the decoration is not mere decoration only, but also has a handling function, i.e. ease of grip of the mandrel, in case a cross-shaped structure for holding and turning in or inserting is not provided. Due to the fact that the handle knob forms the upper end, a thread at the upper portion of the mandrel does not make sense (claim 6), via which thread a tray would be screwed on or a tray placed on the support structure would be fastened by a separate nut (a screw fixing means). The invention can do without a thread.

The components of the individually positionable deposit means (claim 1) include the tray-shaped deposit means (claim 30) and the substantially straight mandrel (claim 22).

The tray-shaped deposit means (claim 30) comprises an opening which is preferably centrally aligned and the axis of which forms the center axis of this tray-shaped deposit means. The opening is adapted and configured to be guided over the upper portion of the straight mandrel. The deposit means comprises a number of tubular inserts which are circumferentially distributed. The circumferential distribution is oriented towards the said center axis. If the tray is round in shape, the circumferential distribution may also be determined by a uniform spacing from an edge of the surface area of the tray. Each one of the tubular inserts is configured to receive one drinking vessel each, wherein the inserts each have a base. The base holds the drinking vessel and supports the drinking vessel placed in the insert, respectively.

A plurality of these tray-shaped deposit means can be stacked on top of each other in the state removed from the mandrel, wherein the tubular inserts come to rest inside of each other. Preferably, they are conical in shape at least in the lower portion (claim 33). The bases of the inserts may have a sieve-like configuration so that water (or spilt drinks) may drain off (claim 31). A low number of hole-shaped apertures up to a single one in the base of a respective tubular insert are/is sufficient.

If one single aperture is provided, this aperture may be smaller than the base and be arranged off-center. This results in a double use of this aperture as a drain for liquids and simultaneously as a cup holder which cup is inserted through this aperture to a certain extent (claims 31, 34). The possibility of insertion to a limited extent only is achieved in the case of a cup expanding conically upwards. It is inserted into the base aperture to a certain extent and since it is arranged off-center, the cup can abut on the wall of the tubular insert at an axially different height. The cup is thus, just as the tray, stably held in its position of rest.

The at least one base aperture represents a sieve-like configuration of the base which means that not the entire base is recessed but only a part thereof or a plurality of individual apertures are provided.

A further tubular insert may be provided, the base of which is not perforated (claim 32). It is configured and adapted for use as an ashtray.

The other component of the individual deposit means according to claim 1 is the substantially straight mandrel (claim 22). It comprises an upper portion and a lower portion. The lower end portion of the lower portion is adapted to be turned or inserted into the subsurface, however, only to a small extent. Measured from the lowermost end, the substantially straight mandrel comprises a horizontally extending support structure at a specific height above this lower end. This support structure is located at the upper end of the lower portion. This support structure is formed in the horizontal direction. Thus, by means of its surface extension, it is adapted for receiving and holding a tray-shaped deposit means in order to stably hold (support) this tray-shaped deposit means at a constant axial height.

The horizontally extending support structure is preferably shaped as a ring (claim 26). The horizontal extension is determined on the basis of the vertical axis of the substantially straight mandrel and corresponds to a plane extending perpendicularly to this axis.

The upper portion may broaden in the downward direction (claim 23). The lower portion may also broaden in the upward direction. The respective final thicknesses of the upper portion and the lower portion are not identical so that a step is formed, which is a component part of the horizontally extending structure. This step may have the to said ring shape lying in the horizontal plane which extends perpendicularly to the vertical axis of the substantially straight mandrel.

Said two expansions may preferably be rotationally symmetrical, i.e. may be interpreted in the manner of a circle having a radius increasing in the upward direction for the lower portion and increasing in the downward direction for the upper portion. Then a shape using continuous expansions, without formation of intermediate steps, is obtained (claim 27). However, a single step remains which is a component part of the horizontal support structure and is located between the two largest radial dimensions of the two portions (claim 27).

An operating handle, in particular a handle knob, can be provided at the upper end of the upper portion (claim 24). It has a diameter which is at least smaller, preferably considerably smaller than the opening the tray-like deposit means comprises for being slid over the upper portion in order to be able to rest on the horizontally extending support structure.

If the handle knob is provided, a thread at the upper portion of the mandrel does not make sense (claim 25). It is thus free of thread.

A dimension of the (planar) horizontally extending structure is in any case greater than the horizontal dimension of the radially expanding operating handle. The radial outer dimension of the ring shape is preferably even twice the size of the greatest dimension of the radially expanding operating handle, provided that such a handle is present.

If the operating handle is spherical and the horizontally extending support structure has the shape of a circular ring, the greatest diameter of the support structure can be greater than twice the spherical diameter of the operating handle. This is a preferred example of shapes.

The Figures describe examples of the invention. Two-piece systems are disclosed.

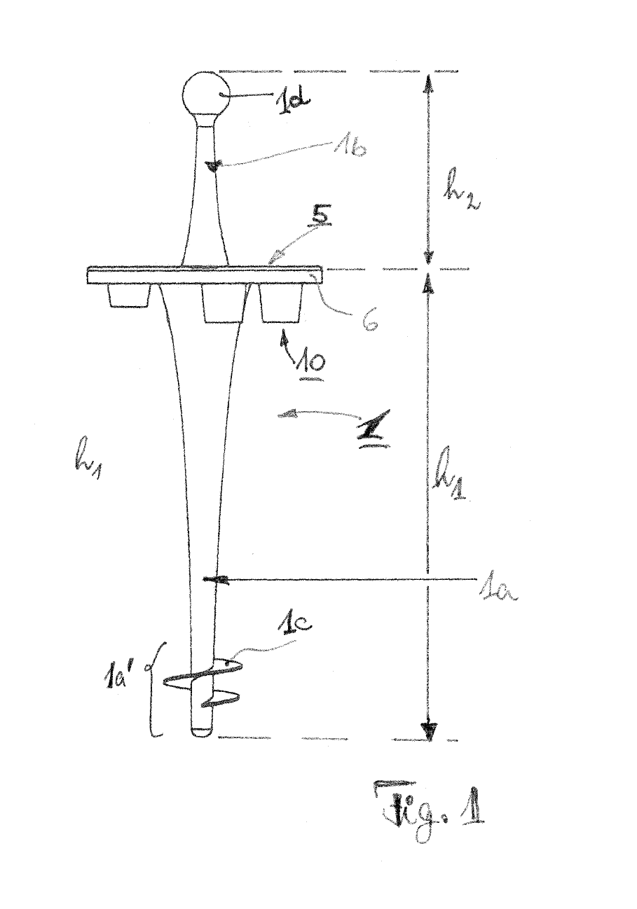

FIG. 1 shows in side view a deposit means provided with a single leg only which is comprised of a mandrel 1, a tray-like deposit means 5 and receptacles 10 for drinking vessels arranged therein.

FIGS. 2, 2a show in side view and vertical cross section a further example for insertion into the subsurface.

FIG. 3 shows the deposit means provided with a single leg without the spiral 1c for insertion into a different subsurface. Also in this case, the tray 5 is attached. It can be attached and removed.

FIG. 4 shows the removed tray 5 having a substantially central opening 5a.

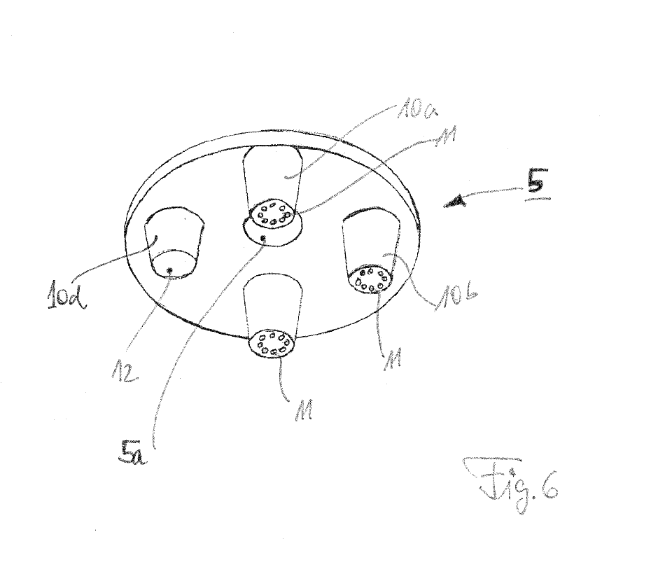

FIGS. 5a, 5b, 5c, 5d show a number of views of the tray 5 in perspective, side and bottom view. The tubular recesses 10 having a sieve-like structure 11 at their bases 12 for draining off water are apparent therein.

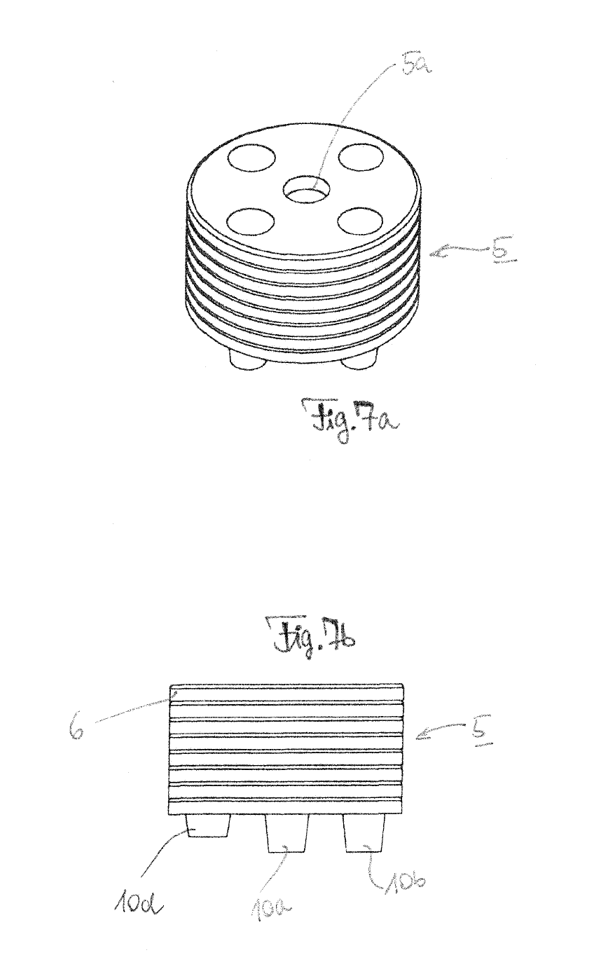

FIG. 6 shows a further enlarged view of the tray-shaped deposit means 5, on the left side of which a recess 10d not perforated at the base 12 can be seen which may be used as an ashtray.

FIGS. 7a, 7b show a plurality of stacked tray-shaped deposit means 5, wherein the respective openings 5a are centrically arranged on top of each other. The tray-shaped deposit means 5 are centered with respect to each other on a stack by means of an edge 6 and can be lifted off individually.

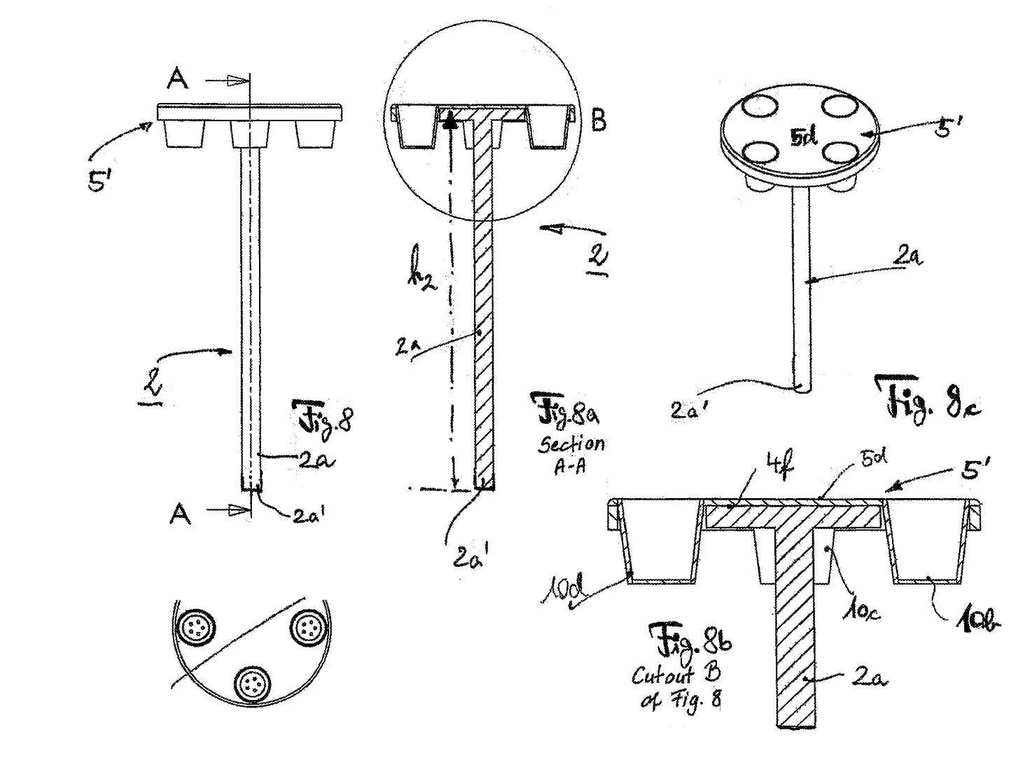

FIGS. 8, 8a, 8b, 8c show a further example of the invention comprising a mandrel 2 not having an upper portion, but having a lower portion 2a only.

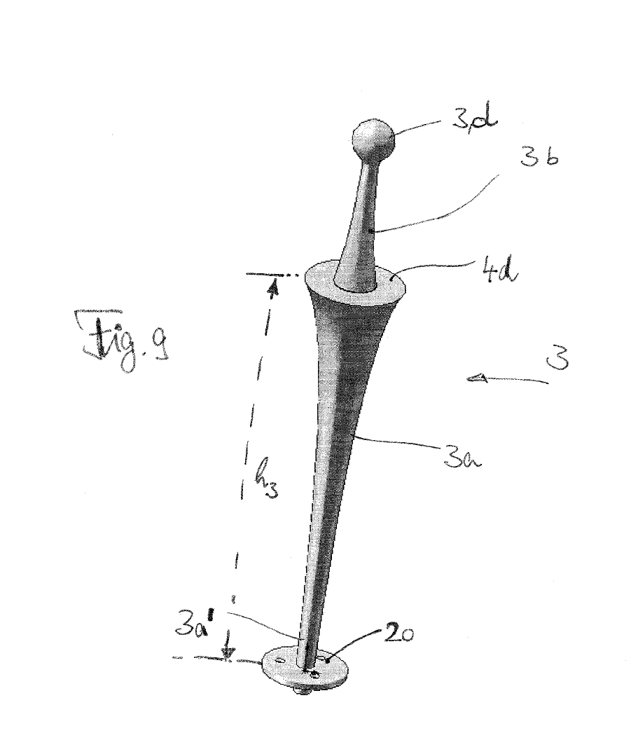

FIG. 9 shows a substantially straight mandrel wherein the horizontally extending structure 4d, as used in the embodiment of FIG. 2, is apparent. Likewise, the mandrel of FIG. 9 having a modified lower end according to FIG. 1 could form the example of this Figure with respect to the horizontally extending planar structure 4d.

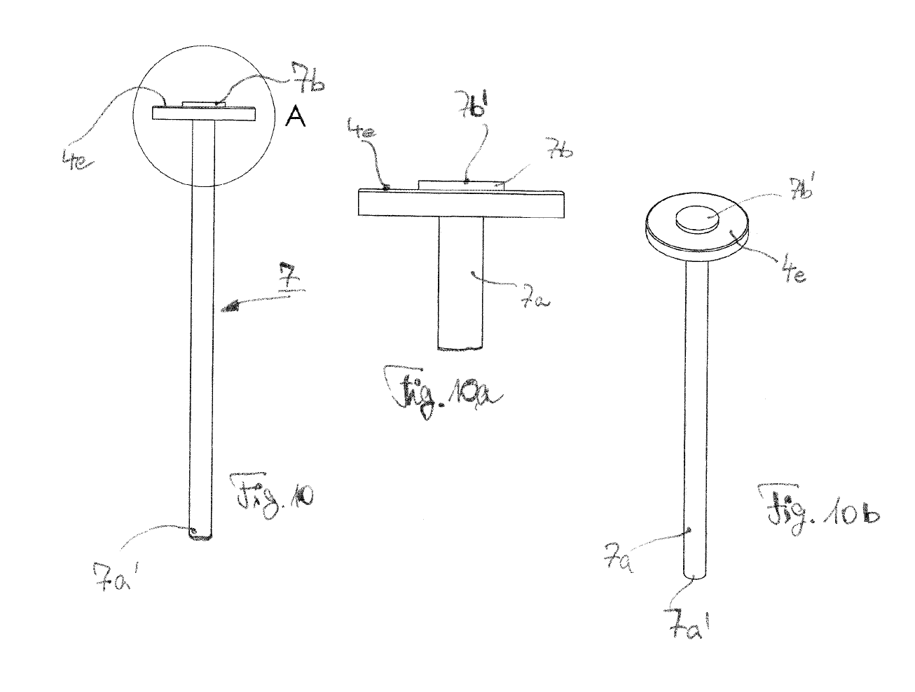

FIGS. 10, 10a, 10b show a further embodiment of the invention wherein a rudimentary upper portion 7b of the mandrel 7 is present which is a mere protrusion 7b. It is configured to engage the central hole 5a of a corresponding tray, which is not illustrated here. In other words, the opening 5a of the tray is guided over the upper portion 7b of the mandrel 7 according to FIG. 10.

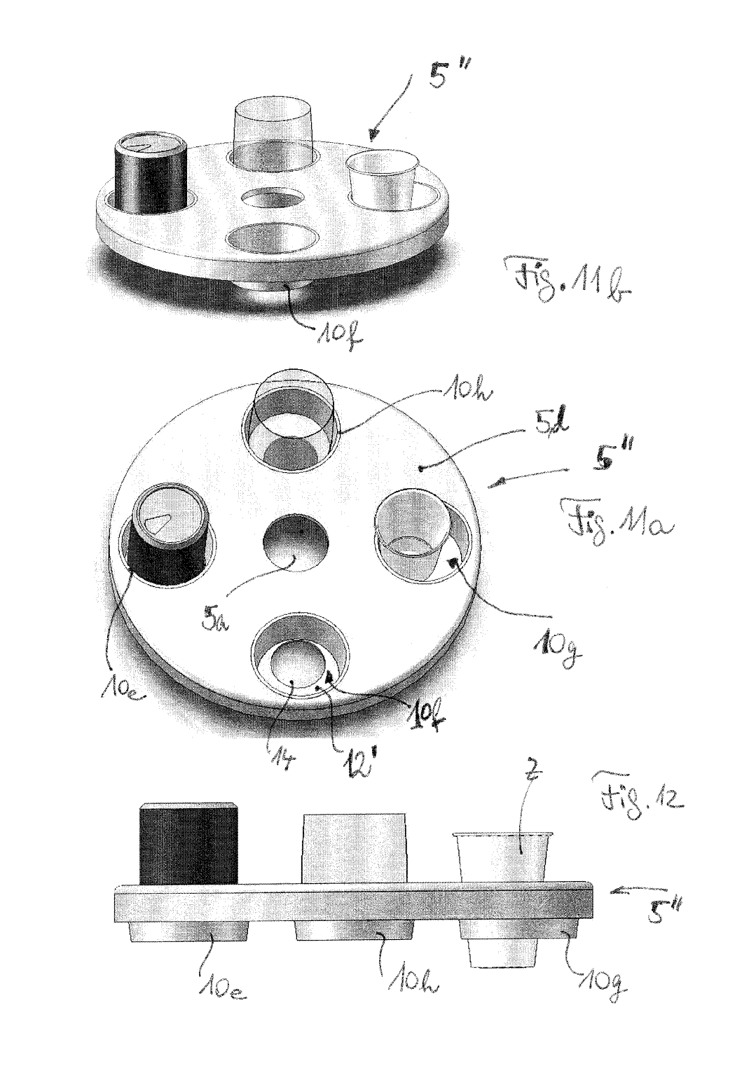

FIGS. 11a, 11b are two views of a modified tray-shaped deposit means 5″. The base aperture of the bases of the tubes 10f, 10g, 10g and 10e illustrated therein is modified as compared to the configuration of FIG. 5.

FIG. 12 shows a side view of the embodiment of FIG. 11.

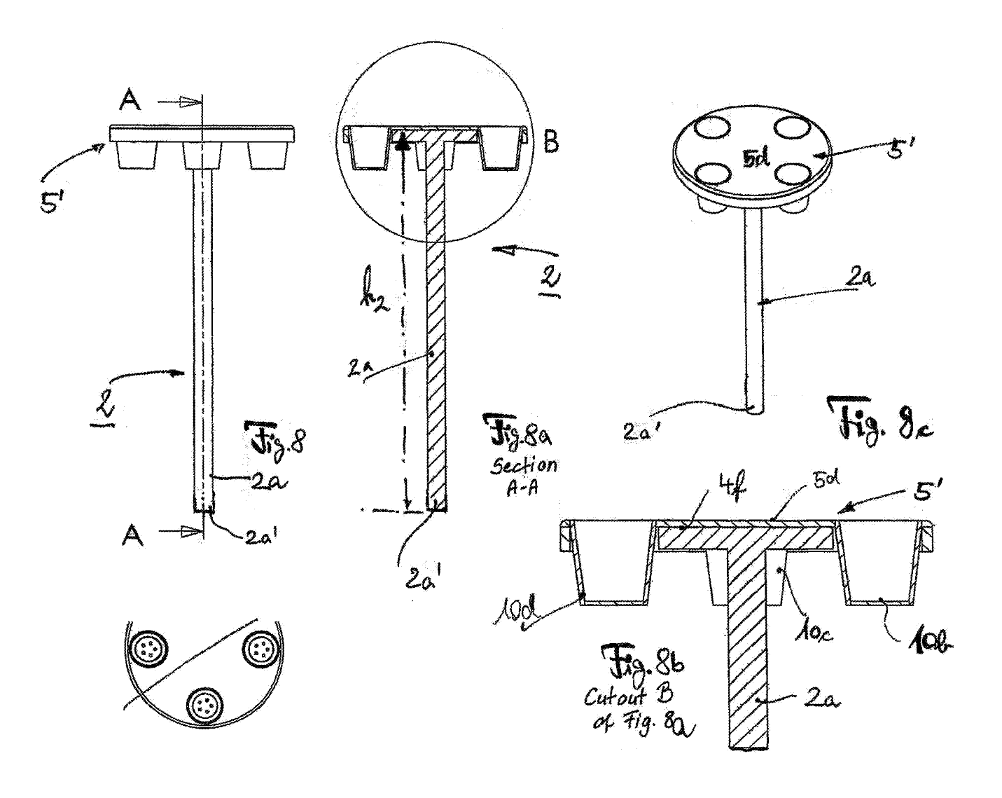

FIG. 13 illustrates a bottom view wherein the modified sieve-like structure 14 of the base of the tray 5″ of FIG. 11 is shown more clearly.

FIG. 14 shows a top view of the embodiment of FIG. 11 wherein a cup Z, a can X and a glass Y are placed therein.

The horizontally extending structure, which is not apparent from FIG. 1, can be explained more clearly with reference to FIGS. 2 and 2a. The tray 5 is slid over the upper portion 3b and rests on the horizontal structure 4d also therein. FIGS. 1 and 2 are comparable to each other here. The difference resides only in the lower end portion 3a′ of FIG. 2 as compared to the lower end portion 1a′ of FIG. 1. Two different shapes are shown here which are alternatively adapted for turning and inserting into the subsurface.

In FIG. 2a, the opening 5a of the tray-shaped support 5 is guided over the upper portion 3b. The operating handle 3d, having the shape of a sphere in the example, has a smaller diameter than the opening 5a as a central hole of the tray-shaped deposit means 5. The deposit means 5 comprises a (freely) selectable number of tubular inserts 10a, 10b which, in the shown example, are involved in blocking a lateral slipping due to their conical shape. In addition to the adjustment of the innermost position of the tubular insertion aids, the adjustment of the central hole 5a to the transverse extension of the lower end of the upper portion 3b serves the purpose of centering. Both adjustments have centering functions, they are both capable of bringing about this centering function or limiting a transverse displacement to a maximum dimension which, in the example, is less than 1 cm, preferably less than 0.5 cm. Each of the mentioned centering aids and displacement stops can be operated on its own, for example, when the central hole 5a is larger in size or when the inner dimensions of the tubes do not touch the outer dimensions of the horizontally extending structure 4d.

A cup Z is inserted into a tube 10 and rests on the base.

It is sufficient when the tubular insertion aids 10 are conical in shape at their lower end portion only and not along their entire length. Also in this case, a centering effect cooperating in a centering manner with the outer edge of the planar horizontal structure 4d can be achieved. Incidentally, the tubes can then be cylindrical in shape, wherein the maximum inner dimension of the plurality of distributed cylinders must not be less than the outer extension of the horizontal surface structure 4d.

Mounting or assembly is performed as follows which is equally applicable to FIG. 1 or 2. FIG. 3 shows the example of FIG. 2 in perspective view. The adjustment of the diameter of the central hole 5a to the transverse extension of the lower end portion of the upper portion 3b of the mandrel is apparent here.

Firstly, the insert mandrel 1 or 3 is turned or inserted into the ground as a carrier at a freely chosen place. Then, the tray-like deposit means with its (in most cases central) opening 5a is guided over the upper portion 3b, 1b of the respective carrier 3, 1 and is stably placed or attached at a specific height h₁ by placement on the horizontally extending structure 4d. The horizontally extending structure is comprised of a ring-shaped plate portion 4d not having arms, but extending horizontally and providing a certain extent of a horizontal surface area on which the tray may be placed (after its opening 5a has been guided over the upper portion 1b or 3b), cf. also the separate illustration of the mandrel in FIG. 9.

The horizontally extending structure 4d as a ring-shaped structure can be seen better in perspective therein. The height is h₃ which substantially corresponds to height h₁ of FIG. 1 minus the insertion depth of the front portion 3a′ into the base part 20 of FIG. 9.

The base part 20 itself may also be simply the subsurface without a separate base part 20 which may additionally be present for non-perforable subsurfaces, for example, stone slabs, wooden planks or metallic surfaces.

Holding the tray-shaped deposit means 5 on the horizontal structure 4d can be readily achieved, since no additional screwing means or threads are present, by which the tray is fixed to the mandrel. The tray rests stably thereon and will not tilt. The tray can also be rotated in its attached position without having to turn the mandrel separately.

The attached state of FIG. 3 can be released again and the tray can be drawn over the upper portion 3b in the vertical direction and removed. The insert mandrel 3 or turn-in mandrel 1 may stay in place, while the tray can be taken along and stored elsewhere. It may also be stacked, wherein a circumferential edge 6 is useful as explained further below. However, a completely continuous edge 6 at the tray is not required.

Generally speaking, the tray-shaped deposit means has been coupled to a horizontally extending carrier, wherein the tray rests on the carrier and can be removed therefrom. The tray-shaped deposit means includes a number of insertion possibilities for drinking vessels.

The tray-shaped deposit means 5 can be emptied and cleaned after removal. It does not need to be put back on the carrier as the substantially straight mandrel; the deposit means may rather be stored in a stack—similar to beach loungers—also in a safe place until they are reused. They may also be stored remote from the mandrel 1 or 3.

The embodiment of FIG. 9 has already been mentioned with reference to FIG. 3. The mandrel illustrated here is shown in perspective view corresponding to that of the mandrel 1 of FIG. 1. The mandrel 3 comprises a lower portion 3a and an upper portion 3b. The same applies to the mandrel of FIG. 3. The lower portion 3a has a lower end portion 3a′ inserted into a receiving means 20 which may be mounted to the mentioned firm ground. In a configuration corresponding to FIG. 1, a spiral corresponding to the spiral 1c of FIG. 1 can be attached to portion 3a′ without using the receiving means 20 (not shown separately).

The horizontal support structure 4d is capable of (stably) holding the tray 5 when the tray is slid downwards over the upper portion 3b coming to rest on the support ring as the horizontal support structure at height h₃. The diameter of the opening 5a of the tray 5 corresponds to the greatest transverse extension of the lower end of the upper portion of the mandrel, cf. FIG. 4, at least corresponding to the extension corresponding to the outer dimension of the handle 3d, in particular when shaped as a spherical operating handle.

The horizontal support structure 4d may be interpreted as a step at height h₃ which is created when an upwards expanding lower portion 3a and a downwards expanding upper portion 3b are present. The respective ends, which converge in the horizontal support structure 4d, are not identical in size in the transverse direction, but differ considerably, as shown in FIG. 9. This is also apparent from FIGS. 1 and 2.

The broadening of each of the two portions towards the horizontal support structure 4d, which is shaped as a ring in FIG. 9², is continuous in the example, i.e. has no edges or steps or potential threads. Only a support step 4d as the horizontal support structure is created having, for example, a minimum dimension in order to reliably fulfill the holding function for the tray-like deposit means 5. For this purpose, its width is at least 40% of the outer diameter of the tray-shaped deposit means 5. If the dimensions of the horizontal support structure are sized in this way, an additional arm for further support of the tray is not required. The ring-shaped step of the said width is then sufficient. The width corresponds, for example, to the outer diameter of the ring 4d. The inner diameter is determined by the width of the upper portion 3b at its lower end. ² This and lines 31 and 33 are intended to read FIG. 9 instead of FIG. 8.

For attachment, the tray is moved over the upper portion 3d, 3b from above downwards and is attached to the horizontal support structure 4d. For removal, this movement is performed in the inverse direction and the tray is removed upwards from the horizontal support structure over the upper portion 3b, 3d.

As to the configuration or various configurations of the tray-like deposit means 5, it is referred to the previous Figures. These configurations can be readily applied to the mandrel 3 of FIG. 9. The diameter of the opening 5a is to be adjusted to the dimension of the lower diameter of the upper portion 3b of the mandrel 3 and the handle 3d of the mandrel 3 of FIG. 9 must not be greater than the diameter of the opening 5a of the tray-like deposit means 5.

FIG. 10 shows a further embodiment. The upper portion 3b of FIG. 9 is rudimentary here. It is apparent from FIG. 10a that a rudimentary residual portion 7b protrudes upwards relative to the support surface 4e which is configured analogously to the one which is designated by 4d in FIG. 9. It is also ring-shaped, however, the mere protrusion does not protrude beyond the central hole 5a when the tray 5 is attached. Preferably, the surface 7b′ of the protrusion 7d forms an even surface with the tray surface 5d.

For attaching the tray 5 of FIG. 4 to the horizontally extending support structure 4e, to the central opening 5a of the tray is guided over upper portion 7b of the mandrel 7. The diameter of the protrusion 7b is adjusted to the tray opening 5a. A lateral slipping cannot take place, is at least inhibited or blocked to a certain extent before the user gets the feeling of an insecure tray support. Preferably, the range of the lateral slipping is virtually zero, in any case not greater than 1 cm, preferably at most 5 mm.

What has been said before with respect to the dimensions of the horizontal support structure 4d (of the horizontally extending structure) also applies to the dimensions of the support 4e.

The support structure shaped as a ring in the example is at least 40% of the diameter of a round tray 5 which is not illustrated in FIG. 10. FIG. 10b is a perspective view which renders the surface 7b′ of the protrusion 7b and the horizontal structure 4e visible.

The substantially straight mandrel 7 comprises a lower portion 7a, the lower end portion 7a′ of which is adapted for insertion into the subsurface. An alternative configuration according to FIG. 1 including the spiral 1c for turning in is also possible.

According to another definition, the horizontally extending structure 4e is at least 20 cm², preferably at least 40 cm² in size. This effective surface area is sized such that the outer dimensions, the outer ring in the example of a circle, determine the surface area, and the protrusion is not a physical surface on which the tray 5 rests, but effectively is part of the surface area. It is taken into account in the surface dimensions of at least 20 cm².

In not shown examples, the physical support disk as the horizontally extending structure 4d may also take other shapes, such as square, polygon-like, triangular or as a disk with radial slots provided therein.

In the manner corresponding to FIG. 2a, a group of tubular inserts 10a, 10b may have a centering effect when the tray 5 is attached to the mandrel 7. In addition to the centering function of the protrusion 7b, there is also the centering function of the downwards protruding tubes. The two centering functions can be combined, but may also be used individually.

A further embodiment which may dispense with the upper portion of the substantially vertical mandrel and does not comprise a central opening 5a of the tray is shown in FIG. 8. FIG. 8c shows that the tray 5′ has a smooth surface 5d which is only interrupted by the tubes into which beverage cups or beverage bottles or cans can be placed. Ashtrays may also be provided. The corresponding configuration of the tray emerges from FIGS. 5, 6 and 7. In each case without the central opening 5a shown therein.

The lower end portion 2a′ of the mandrel 2 is adapted for insertion into a subsurface. It can also be provided with a spiral, shown as 1c in FIG. 1. The mandrel does not comprise an upper portion, but comprises only a support surface 4f instead extending in the horizontal direction. This support surface 4f is apparent from FIG. 8b which is a cutout B of FIG. 8a.

The lower portion of the mandrel is 2a which virtually constitutes the entire length of the mandrel 2.

To the support surface as an effective surface 4f the statement applies that a stable support of the tray 5′ is obtained. This stable condition is achieved by both the surface extension and the restriction of a transverse displacement which is here accomplished by the tubular inserts alone which are apparent as 10d, 10c and 10b from the enlarged cutout. Their innermost dimensions are positioned such that they virtually abut the edge of the horizontally extending support structure 4f. Due to the conical configuration, a centering function can be achieved when attaching the tray 5′. A transverse displacement can be blocked virtually completely.

A stable support is ensured by the size of the surface extension of the horizontal structure 4f. It amounts to at least 20 cm², preferably additionally at least 16% of the surface area of the tray (without subtracting the tube openings), i.e. the inner surface area defined by the outer dimensions of the tray. This value is in any case greater than 10%, preferably greater than 16% or at best >20%. In the case of a circular configuration as shown here which is, however, not necessarily given to the tray 5′, and not necessarily given to the horizontally extending support means 4f as a circular structure, outer dimensions of at least 40% of a diameter of the tray in relation to the minimum extension of the horizontally extending support surface 4f are obtained.

Various embodiments of tray-like structures can be found in FIGS. 5, 5a, 5b and 5c. The bases are perforated by a plurality of apertures here. One base 12 is non-perforated and may serve as an ashtray.

The perforation in the bases of the tubular inserts 10 can also be configured in a different way, as shown in FIGS. 11 to 14. By means of the variety of illustrations, they are largely self-explanatory. The various vessels which may be placed therein include a cup Z having a conical outer wall, a beverage can Y having a cylindrical outer wall, a glass X having a curved lateral surface and random other glasses which are not illustrated separately.

The central opening 5a corresponds to that of FIG. 5. The base aperture 14 in FIG. 13 is configured differently from the perforation of FIG. 5a including a plurality of holes. Here, a sieve-like base structure is configured with one hole only which is preferably arranged off-center so that an inserted cup having a conical wall structure, such as cup Z, is not only held annularly by insertion through the base to an extent limited in length, but is also held laterally to a certain extent at the inner wall of the tubular insertion aperture, which second holding position is located axially higher than the lower ring supporting the cup in the axial direction.

Cylindrical beverage cans cannot fall through due to the reduced aperture width of the base aperture 14, but stand on the remaining residual base 12′, as shown in the example on the left side of FIG. 14.

Due to the base through hole 14, the tubes can be provided with a lower axial height, as shown in FIG. 12 in contrast to the illustration of FIG. 6. The height/depth of the tubular inserts is reduced and can be used for saving material. Cups placed therein will nevertheless be reliably held (laterally and axially), also in the case of a high wind arising on the beach, by the river or in the snow-covered mountains.

1. An individually positionable deposit device configured as a cup holder above a ground characterized by a two-piece system, comprising:
a substantially straight mandrel (1, 2, 3, 7) having an upper portion (1b, 7b, 3b) and a lower portion, said lower portion configured for turning or inserting into the ground and said mandrel comprising a horizontally extending structure (4d, 4e) at a given height above an end of the lower portion, said structure configured and suitable as a holding support for a tray-like support device (5, 5″); and
wherein the tray-like support device comprises an opening (5a) configured in size to be guided over the upper portion of the mandrel (1, 2, 3, 7) so as to rest on the horizontal structure (4d, 4e) and supported thereby.

2. The deposit device according to claim 1, wherein the horizontally extending structure (4d, 4e) is shaped as a ring.

3. The deposit device according to claim 2, wherein the ring (4d) has an outer dimension which amounts to at least 40% of a diameter of a round tray-like support device (5).

4. The deposit device according to claim 1, wherein the upper portion (1b, 3b) broadens in the downward direction and the lower portion (1a, 3a) also broadens in the upward direction, wherein the final thicknesses of the two portions are not identical and form a step (4d).

5. The deposit device according to claim 1, further comprising a radially expanding operating handle.

6. The deposit device according to claim 1, having no thread at the upper portion (1b, 2b, 3b).

7. The deposit device according to claim 4, wherein the step (4d, 4e) has, at least in sections, a planar configuration.

8. The deposit device according to claim 1, wherein a surface area of the planar structure effectively is at least 20 cm² in size.

9. The deposit device according to claim 1, wherein the upper portion (1b, 7b) of the mandrel (1, 7) is shorter than the lower portion.

10. The deposit device according to claim 9, wherein the upper portion (7b) is a mere protrusion adapted to reach through the opening (5a) of the tray-shaped support device.

11. The deposit device according to claim 10, wherein a diameter of the protrusion and a diameter of the tray opening (5a) are adjusted to each other to center the tray-shaped support device on the horizontally extending structure and still remaining rotatable.

12. The deposit device according to claim 1, wherein the lower portion (1a) of the mandrel is provided with a spiral (1c) at a lower end portion (1a′) thereof.

13. The deposit device according to claim 1, wherein the tray-like support device (5, 5″) comprises at least one tubular insert (10a, 10b, . . . , 10f, 10g) for at least one drinking vessel each.

14. The deposit device according to claim 13, wherein each tubular insert has a sieve-like base structure (11) for draining off liquid.

15. The deposit device according to claim 1, wherein the tray-like support device (5) comprises a recessed ashtray (10d) having a closed base.

16. The deposit device according to claim 1, wherein a plurality of tray-like support devices (5) are provided which can be stacked on top of each other in a state not attached to the mandrel (1, 2, 3, 7).

17. The deposit device according to claim 13, wherein each tubular insert (10a, 10b, 10f), in its position in the tray-shaped support device, is adjusted to a transverse extension of the horizontally extending structure (4d, 4e) such that at least one of:
a lateral displacement of the tray (5, 5″) resting on the horizontal structure can be blocked;
a transverse displacement by no more than 1 cm takes place or a transverse displacement exceeding this value is blocked; and
a centering effect takes place when the tray (5, 5″) is guided over the upper portion (1b, 7b).

18. The deposit device according to claim 13, wherein each tubular insert has, at least in sections, a conical configuration along its height.

19. The deposit device according to claim 10, wherein a size or thickness of the tray-shaped support device (5, 5″) is less than an axial height of the protrusion (7b).

20. The deposit device according to claim 1, wherein a surface area of the planar structure (4d, 4e) is greater than 10% of a surface area of the tray (5, 5″).

21. The deposit device according to claim 20, wherein the surface area of the planar structure (4d, 4e) is greater than 16% of the surface area of the tray (5, 5″).

22. A straight mandrel (1, 2, 7) for an individually positionable deposit device comprising:
an upper portion and a lower portion, said lower portion (1a, 2a, 3a, 7a) configured for turning or inserting into the ground along a portion (1c; 3a′, 2a′), and said straight mandrel comprising a horizontally extending planar support structure (4e, 4d) at a specific height (h₁, h₃) above a lower end of the lower portion; and
said horizontally extending support structure (4e; 4d) having a minimum surface area of 20 cm² and being configured as a holding support for a fray-like support device (5, 5″) for holding the same at a substantially constant height (h₁, h₃) in an axial direction.

23. The mandrel according to claim 22, wherein the upper portion (1b, 2b, 3b) broadens in the downward direction and the lower portion (1a, 2a, 3a) also broadens in the upward direction, wherein final thicknesses of the two portions are not identical and form a step (4d) as a component part of the horizontally extending structure.

24. The mandrel according to claim 22, further comprising a radially expanding operating handle comprising a handle knob (1d, 2d, 3d) at an upper end of the upper portion (1b, 2b, 3b).

25. The mandrel according to claim 24, not having a thread at the upper portion (1b, 2b, 3b).

26. The mandrel according to claim 22, wherein the horizontally extending structure is shaped as a ring (4d, 4e).

27. The mandrel according to claim 23, wherein the broadenings are continuous without forming any steps such that the only step (4d) is the one between the greatest radial dimensions of the upper and lower portions.

28. The mandrel according to claim 22, wherein the horizontally extending support structure is adapted to enable a stable self-support of the tray (5, 5″) which is only placed thereon.

29. A method for one of releasing and connecting a tray-like support device (5) with respect to a mandrel (1, 2, 7) comprising:
providing mandrel upper and lower portions, said lower portion configured for turning or inserting into the ground along a portion, wherein the mandrel comprises a horizontally extending planar support structure at a specific height above a lower end of the lower portion, said horizontally extending support structure having a minimum surface area of 20 cm² and being configured as a holding support for a tray-like support device for holding the same at a substantially constant height in an axial direction;
one of attaching and removing the tray (5, 5″) from the horizontal support structure (4d, 4e) via the upper portion (1b, 3b, 7b).

30. A tray-shaped support device comprising:
an axially continuous opening (5a), configured to be guided over an upper portion (7b, 3b, 1b) of a straight mandrel, the support device provided with a plurality of tubular inserts (10a, 10b) adapted for one drinking vessel each, wherein each tubular insert has a base (12).

31. The tray-shaped deposit device according to claim 30, wherein at least one of the tubular inserts (10) has a sieve-like configuration with at least one base aperture (14) for draining off water or inserting and passing through a drinking vessel (Z) to a limited extent.

32. The tray-shaped deposit device according to claim 30, wherein a recess (10d) not perforated at the base is provided which is adapted as an ashtray.

33. The tray-shaped deposit device according to claim 30, wherein the tubular inserts are arranged in a circumferentially distributed manner.

34. The tray-shaped deposit device according to claim 31, wherein the base aperture (14) in the base (12) of at least one of the tubular inserts is provided off-center.

35. An individually positionable deposit device adapted as a cup holder above a ground, characterized by a two-piece system, comprising:
a substantially straight mandrel (2) having a lower portion, said lower portion (2a) being adapted for turning or inserting into the ground (2a′), and said mandrel comprising a horizontally extending planar structure (40 at a specific height (h₂) above an end of the lower portion, said structure being adapted as a holding support for a tray-like support device (5);
wherein the tray-like support device is provided with tubular inserts (10a, 10b, 10f) and is adapted to rest and be stably held (6) on the horizontal structure (4f); and
wherein the tubular inserts (10a, 10b, 10f), in their position in the tray-shaped support device, are adjusted to a transverse extension of the horizontally extending structure (40 such that at least one of:
a lateral displacement of the tray (5′) resting on the horizontal structure is blocked;
a transverse displacement by no more than 1 cm takes place or a transverse displacement exceeding this value is blocked; and
a centering effect of the tray (5′) takes place effected by the tubular inserts (10a, 10b, 10f).

36. The deposit device according to claim 35, wherein a surface area of the planar structure is effectively at least 20 cm² in size.

37. The deposit device according to claim 35, wherein a surface area of the planar structure (40 is greater than 10% of a surface area of the tray (5′).

38. The deposit device according to claim 35, wherein the horizontally extending structure (4f) is shaped as a ring, and the ring (4f) has an outer dimension which amounts to at least 40% of a diameter of a round tray-like support device (5′).

39. The deposit device according to claim 5, wherein the handle comprises a handle knob (1d, 2d, 3d) at the upper end of the upper portion (1b, 2b, 3b).

40. The deposit device according to claim 1, wherein a surface area of the planar structure effectively is at least 40 cm² in size.

41. The tray-shaped deposit device according to claim 33, wherein each one of the tubular inserts (10) is conical in shape at its lower end portion.

42. The tray-shaped deposit device according to claim 34, wherein the tubes or tubular inserts extend to an edge of the base (12).

43. The deposit device according to claim 35, wherein a surface area of the planar structure is effectively at least 40 cm² in size.

44. The deposit device according to claim 35, wherein a surface area of the planar structure (4f) is greater than 16% of a surface area of the tray (5′).
